(19) United States
(12) Patent Application Publication
(10) Pub. No.: US 2020/0298621 A1
(43) Pub. Date: Sep. 24, 2020

(54) AXLE HOUSING EXTENSION MEMBER AND METHOD FOR ADJUSTING TRACK WIDTH OF A TRUCK AXLE

(71) Applicant: Volvo Truck Corporation, Göteborg (SE)

(72) Inventor: Chad Burchett, Browns Summit, NC (US)

(21) Appl. No.: 16/768,519

(22) PCT Filed: Dec. 4, 2017
(86) PCT No.: PCT/US2017/064533

§ 371 Date: May 29, 2020

(51) Int. Cl. B60B 35/10; B60B 35/00; B60B 27/00; B60B 35/04

(52) U.S. Cl. CPC B60B 35/1009; B60B 35/04; B60B 27/0052; B60B 35/004

(57) ABSTRACT

An axle extension member configured for attachment to an axle flange of a truck may be used to modify the truck from a standard track configuration to a wider track configuration to accommodate super single wheels. Methods for adjusting track width of a truck axle are also provided. The axle extension member includes an annular spacer portion and a spindle portion configured to receive an extended length axle shaft therethrough. The annular spacer portion is configured to abut and attach to an outboard face of the axle flange. At least one attachment feature is configured for attaching a disc brake assembly to the axle extension member.

### FIELD OF THE DISCLOSURE

The disclosure relates generally to adjustment of track width of a truck axle. In particular aspects, the disclosure relates to an axle housing extension member configured for attachment to an axle flange of a truck to modify the truck from a standard track configuration to a wider track configuration, such as may be desirable to reconfigure an axle originally intended to receive a dual-tire wheel assembly to instead receive a single wide (or “super single”) wheel.

### BACKGROUND

One way of improving fuel economy in heavy trucks is to replace dual rear tires with super single rear tires to reduce rolling resistance and weight. A significant contributor to rolling resistance is energy loss due to tire sidewall deformation, and the conversion of dual-tire assemblies to super single tires inherently reduces the number of tire sidewalls per axle by half. Replacing standard width truck axles with wider track axles specifically suited for super single rear tires can be difficult and expensive. However, if a truck operation simply fits wheels having super single tires to a standard truck axle, maintenance problems may result.

A super single wheel includes a wheel hub that is offset in an outboard direction relative to a dual tire wheel. As explained with reference to FIGS. 1A-1C, mounting super single rear tires to a standard track rear axle may shift a mechanical load center applied between inner and outer wheel bearings, creating uneven wheel bearing loads, causing, in turn, premature wheel bearing and/or spindle failure. Increasing loading on an outer wheel bearing may be particularly troublesome when an outer wheel bearing is smaller than an inner wheel bearing (i.e., to accommodate a tapered spindle). Premature failure leads to increased maintenance costs to replace wheel bearings after a short service life, as well as the cost of down time of the vehicle. Additionally, such a configuration leads to a narrower overall track width which may compromise handling of the vehicle.

FIG. 1A is a perspective view of a truck axle housing 100. The truck axle housing 100 includes a central housing portion 102 with a left arm 104A and a right arm 104B extending from opposite sides of the central housing portion 102 (left and right being relative to the drawing). At a distal or outboard end of the left arm 104A is a left axle flange 106A, and at a distal end of the right arm 104B is a right axle flange 106B. Each of the left and right axle flanges 106A, 106B (generally referred to as axle flange 106) includes a plurality of circumferentially spaced apertures 108 for mounting a brake assembly thereto. A left spindle 110A extends from a distal end of the left axle flange 106A and a right spindle 1108 (not shown) extends from a distal end of the right axle flange 106B. The left and right spindles 110A, 1108 (referred to generally as spindle 110) provide supporting surfaces for wheel bearings. A left axle shaft flange 112A is arranged at an outboard end of the left spindle 110A, and a right axle shaft flange 112B (not shown) is arranged at an outboard end of the right spindle 1108. Each of the left and right outboard axle shaft flanges 112A, 112B includes a plurality of circumferentially spaced apertures 114 for mounting a wheel thereto.

FIGS. 1B and 1C are cross-sectional views illustrating for comparison loading of a dual wheel assembly and a super single wheel assembly, as if both were mounted on a standard track width axle configuration. In particular, FIG. 1B is a cross-sectional view of a dual tire wheel 116 as if mounted on a truck axle having a standard track configuration, with the truck load line A-A being substantially centered between inner and outer wheel bearings 120A, 120B. The inner wheel bearing 120A is larger in diameter than the outer wheel bearing 120B, to accommodate a tapered spindle. FIG. 1C is a cross-sectional view of a super single wheel 118 as if mounted on a truck axle also having a standard track configuration, showing the load line A′-A′ being outboard relative to the dual wheel assembly, positioned substantially closer to the outer wheel bearing 120B than to the inner wheel bearing 120A. The unbalanced loading in the illustrated super single wheel applies increased stress on the outer wheel bearing 120B and may result in accelerated wear leading to premature bearing failure.

To avoid premature wear of wheel bearings, super single wheels should be used with truck axles having a track configuration wider than a standard track configuration suitable for use with dual tire wheels. However, retrofitting a truck to replace an axle having standard track configuration with an axle having a wider track configuration is time-consuming, complicated, and expensive. Such a retrofit may include expenses such as the cost of a replacement axle tandem as well as the labor to swap out the axles, hubs, brakes, etc.

Accordingly, the art continues to seek structures and methods for permitting an axle track width to be adjusted with reduced time, expense, and waste.

### SUMMARY

Aspects of the disclosure relate to an axle housing extension member (also referred to here as an axle extension member) and method that permits the track width of a truck axle to be adjusted (e.g., widened). In particular, aspects of the disclosure relate to an axle extension member configured for attachment to an axle flange of a truck to modify the truck axle from a standard track configuration to a wider track configuration suitable for a super single type tire and wheel, as well as methods for adjusting track width of the truck axle. An exemplary axle extension member includes an annular spacer portion and a spindle portion configured to receive an extended length axle shaft extending through aligned internal bores defined through the annular spacer portion and the spindle portion, respectively. The annular spacer portion includes an end face configured to abut an outboard face of the axle flange. The thickness of the annular spacer portion exceeds the thickness of the axle flange by an amount sufficient to adjust a track width of the truck axle from a standard track configuration to a wider track configuration suitable for receiving a super single wheel. Accordingly, the axle extension member provides for retrofit mounting of super single wheels, advantageously locating the load center in a more neutral position between inner and outer wheel bearings.

In one aspect, an axle extension member is configured for attachment to an axle flange of a truck to modify the axle from a standard track configuration to a wider track configuration. The axle extension member comprises an annular spacer portion and a spindle portion. The annular spacer portion comprises an end face defining an inboard end of the axle extension member. The end face is configured to abut an outboard face of the axle flange. The spindle portion extends from the annular spacer portion and defines an outboard end of the axle extension member opposite the annular spacer portion, wherein the spindle portion comprises wheel bearing support surfaces configured to receive wheel bearings of a hub. The annular spacer portion defines a first internal bore. The spindle portion defines a second internal bore aligned with the first internal bore along a central axis. The first and second internal bores are configured to receive an extended length axle shaft.

In certain embodiments, the annular spacer portion and the spindle portion are embodied in a unitary member. In certain embodiments, the axle extension member further comprises a welded interface between the annular spacer portion and the spindle portion.

In certain embodiments, the annular spacer portion defines a plurality of circumferentially spaced apertures extending through the end face in a direction substantially parallel to the central axis. The plurality of circumferentially spaced apertures is aligned with a plurality of circumferentially spaced holes defined in the axle flange. The plurality of circumferentially spaced apertures is configured to receive a plurality of bolts to permit the axle extension member to be attached to the axle flange. In certain embodiments, each aperture of the plurality of circumferentially spaced apertures extends through an entire thickness of the annular spacer portion.

In certain embodiments, the first internal bore is sized and shaped to receive therein a retained spindle segment extending in an outboard direction from the axle flange. In certain embodiments, the first internal bore is sized and shaped to contact at least a portion of an outer wall of the retained spindle segment when the retained spindle segment is received within the first internal bore. In certain embodiments, a wall of the annular spacer portion defines a plurality of radially extending holes configured to receive a plurality of set screws configured to press against an outer surface of the retained spindle segment.

In certain embodiments, an outboard segment of the second internal bore comprises a first diameter, and an inboard segment of the second internal bore comprises a second diameter that is greater than the first diameter.

In certain embodiments, at least one of the annular spacer portion or the spindle portion comprises forged steel.

In certain embodiments, the axle extension member further comprises a brake mounting region defining at least one attachment feature configured for attachment of a disc brake assembly to the axle extension member.

In certain embodiments, the wheel bearing support surfaces are configured to receive rotational surfaces of inner and outer wheel bearings arranged to permit rotation of a single hub piloted wheel having a width of at least about 28 cm. In certain embodiments, when the rotational surfaces of the inner and outer wheel bearings are received on the wheel bearing support surfaces, a vertical load center applied on the single hub piloted wheel is substantially centered between the inner and outer wheel bearings.

In another aspect, a truck comprises at least one axle extension member, the at least one axle extension member comprising the axle extension member as disclosed herein.

In another aspect, a method for adjusting track width of a truck axle comprises cutting off at least a portion of a pre-existing spindle associated with a truck axle housing at a point between an axle flange and an outboard end of the pre-existing spindle to define a retained spindle segment. The method further comprises aligning an axle extension member with the retained spindle segment, wherein the axle extension member comprises an annular spacer portion comprising an end face defining an inboard end of the axle extension member, a spindle portion extending from the annular spacer portion and defining an outboard end of the axle extension member, a first internal bore defined in the annular spacer portion, and a second internal bore defined in the spindle portion and being aligned with the first internal bore along a central axis. The method further comprises receiving the retained spindle segment within the first internal bore. The method further comprises affixing the annular spacer portion to the axle flange.

In certain embodiments, the method further comprises removing a pre-existing axle shaft from at least a portion of the pre-existing spindle, and inserting an extended length axle shaft through the first internal bore and the second internal bore.

In certain embodiments, said affixing of the annular spacer portion to the axle flange comprises use of a plurality of bolts received by (i) a plurality of circumferentially spaced apertures defined in the annular spacer portion and extending through the end face in a direction substantially parallel to the central axis, and (ii) a plurality of circumferentially spaced holes defined in the axle flange.

In certain embodiments, said affixing of the annular spacer portion to the axle flange comprises welding at least a portion of the annular spacer portion to the axle flange.

In certain embodiments, a wall of the annular spacer portion defines a plurality of radially extending holes, and the method further comprises threading a plurality of set screws through the plurality of radially extending holes to press against an outer surface of the retained spindle segment.

In certain embodiments, prior to the cutting off of the at least a portion of the pre-existing spindle, the outboard end of the pre-existing spindle was a first distance from the axle flange, and by affixing the annular spacer portion to the axle flange, the outboard end of the axle extension member is a second distance from the axle flange, the second distance greater than the first distance.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A is a perspective view of a truck axle housing;

FIG. 1B is a cross-sectional view of a dual tire wheel as received by a truck axle having a standard track configuration, with illustration of a truck load line substantially centered between outer and inner wheel bearings;

FIG. 1C is a cross-sectional view of a super single wheel as received by a truck axle having a standard track configuration, with illustration of an offset truck load line positioned substantially closer to the outer wheel bearing than to the inner wheel bearing;

FIG. 2A is a perspective view of the truck axle housing of FIGS. 1A-1D, following addition of left and right axle extension members as disclosed herein to adjust an axle track width from a standard track configuration to a wider track configuration;

FIG. 2B is a side elevation view of the axle extension member of FIG. 2A mounted to an axle flange of a truck;

FIG. 3A is a perspective view of an axle extension member similar to the axle extension member of FIGS. 2A and 2B but with addition of radially extending holes defined through an annular spacer portion;

FIG. 3B is a cross-sectional view of the annular spacer portion of the axle extension member of FIG. 3A;

FIG. 3C is a side elevation view of the axle extension member of FIG. 3A;

FIG. 3D is a side cross-sectional view of the axle extension member of FIG. 3C;

FIG. 4A is a side elevation view of a portion of a housing arm including a pre-existing spindle and indicating a cut line in accord with the invention;

FIG. 4B is a side elevation view of a portion of a housing arm including a retained spindle segment formed by cutting the pre-existing spindle of FIG. 4A along the cut line;

FIG. 4C is a side elevation assembly view of the axle extension member of FIGS. 3A-3D aligned with the retained spindle segment of FIG. 4B;

FIG. 4D is a perspective assembly view of the axle extension member of FIGS. 3A-3D aligned with the retained spindle segment of FIG. 4B, and illustrating a portion of a truck axle housing from which the retained spindle extends;

FIG. 4E is a side elevation view of the axle extension member mounted to an axle flange of the housing arm with the retained spindle segment of FIG. 4B disposed in a bore in the axle extension member;

FIG. 4F is a perspective view of the axle extension member mounted to the axle flange of the housing arm with the retained spindle segment of FIG. 4B disposed in a bore of the axle extension member following attachment therebetween, illustrating the portion of the truck axle housing to which the retained spindle segment is joined;

FIG. 4G is a cross-sectional view showing the attached axle extension member and the retained spindle segment of FIG. 4B;

FIG. 4H is a cross-sectional view showing the attached axle extension member and the retained spindle segment with further illustration of an extended axle arranged within the axle extension member and within the retained spindle segment;

FIG. 5A is a front perspective view of the axle extension member of FIGS. 3A-3D attached to a brake mount, with a wheel flange of an axle proximate to an outboard end of the axle extension member;

FIG. 5B is a rear perspective view of the axle extension member and brake mount of FIG. 5A, with inclusion of the wheel flange;

FIG. 5C is a side elevation view of the axle extension member and brake mount of FIGS. 5A and 5B, without the wheel flange; and

FIG. 5D is a side elevation view of the axle extension member of FIGS. 3A-3D attached to a brake mount according to another embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Details of illustrative embodiments are described hereinafter.

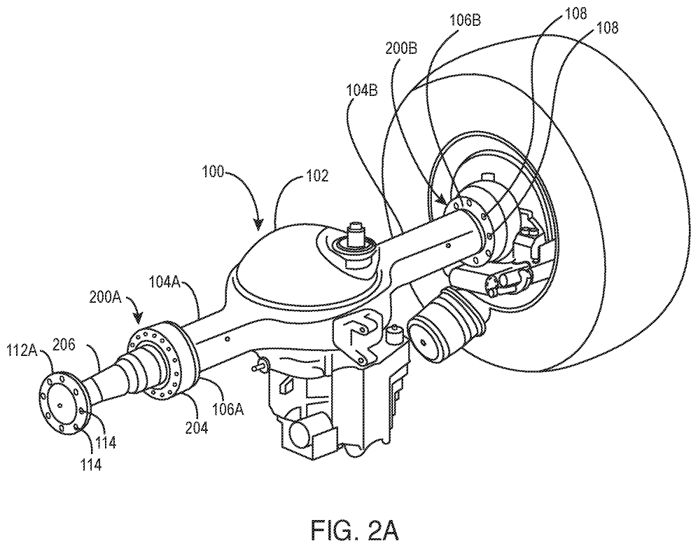

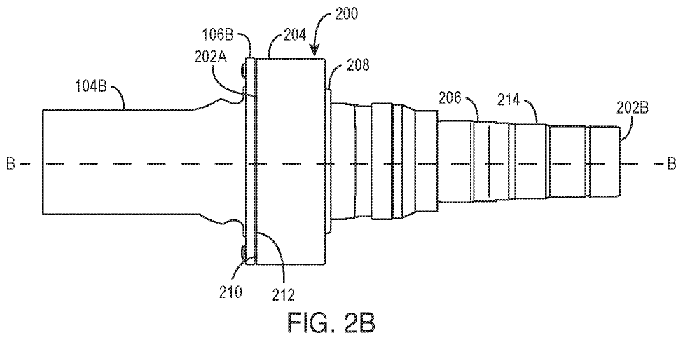

FIG. 2A is a perspective view of a truck axle housing 100, with left and right axle extension members 200A, 200B (referred to generally as axle extension member 200) attached thereto to adjust (i.e., increase) an axle track width. The truck axle housing 100 includes a central housing portion 102 from which a left arm 104A and a right arm 104B extend, with the right arm 104B and the left arm 104A extending from opposite sides of the central housing portion 102 (right and left being relative to the drawing figure). At a distal or outboard end of the left arm 104A is a left axle flange 106A, and at a distal end of the right arm 104B is a right axle flange 106B. Each of the left and right axle flanges 106A, 106B (referred to generally as axle flange 106) includes a plurality of circumferentially spaced apertures 108 (e.g., circumferentially spaced holes) for mounting a brake assembly thereto. As explained in more detail below, the left axle extension member 200A is attached to and extends from a distal end of the left axle flange 106A, and the right axle extension member 200B is attached to and extends from a distal end of the right axle flange 106B. The left and right axle extension members 200A, 200B each include a spindle portion 206 that provides supporting surfaces for inner and outer wheel bearings (not shown). A left outboard axle shaft flange 112A is formed at the end of the axle shaft and extends from an outboard end of the left axle extension member 200A, and a right axle shaft flange (not shown) extends from an outboard end of the right axle extension member 200B. The left and right outboard axle shaft flanges 112A, 112B (referred to generally as outboard axle shaft flange 112) each include a plurality of circumferentially spaced apertures 114 for mounting a wheel thereto.

FIG. 2B is a side elevation view of the axle extension member 200 mounted to the right axle flange 106B. The axle extension member 200 is configured for attachment to the axle flange 106 of a truck to modify the truck from a standard track configuration to a wider track configuration. The axle extension member 200 includes an inboard end 202A, an outboard end 202B opposite the inboard end 202A, and a central axis B-B extending therethrough. The axle extension member 200 includes an annular spacer portion 204 and a spindle portion 206 with a mating interface 208 therebetween. In certain embodiments, the mating interface 208 is a welded interface. In other embodiments, the annular spacer portion 204 is integrally formed with the spindle portion 206 at the mating interface 208.

The annular spacer portion 204 (which may serve as a spacer disk) includes an end face 210 defining the inboard end 202A. The end face 210 is configured to abut an outboard face 212 of the left axle flange 106A (shown in FIG. 2A). The spindle portion 206 extends from the annular spacer portion 204 and defines the outboard end 202B. The spindle portion 206 includes wheel bearing support surfaces 214 configured to receive inner and outer wheel bearings of a hub. Accordingly, the axle extension member 200 is configured to adjust the axle track width and center the load line on an approximate center of the spindle portion 206, with such load line being generally equidistant between the inner and outer wheel bearings (not shown) supportable on the spindle portion 206. As explained in more detail below, the annular spacer portion 204 defines a first internal bore, and the spindle portion 206 defines a second internal bore aligned with the first internal bore along the central axis B-B. The first and second internal bores are configured to receive an extended length axle shaft.

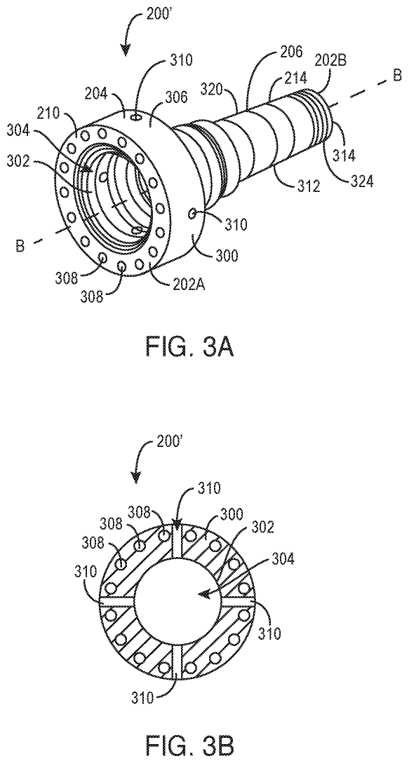

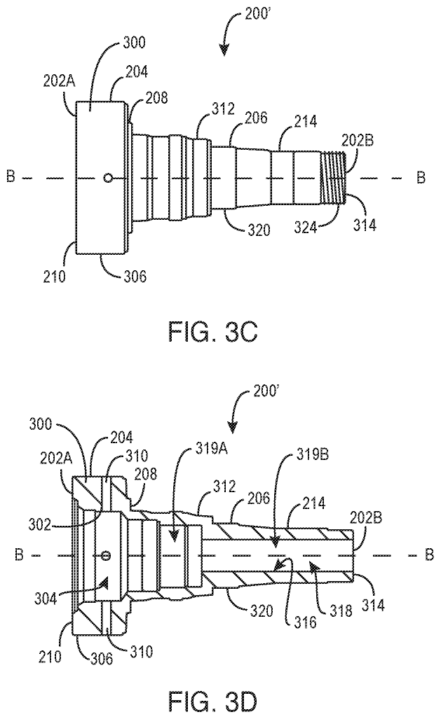

FIGS. 3A-3D illustrate an axle extension member 200′ that is similar to the axle extension member 200 of FIGS. 2A and 2B but with the addition of a plurality of radially extending holes 310 defined through the annular spacer portion 204. The axle extension member 200′ includes an inboard end 202A, an outboard end 202B opposite the inboard end 202A, and a central axis B-B extending therethrough. The axle extension member 200′ includes an annular spacer portion 204 and a spindle portion 206 with a mating interface 208 therebetween. Referring to FIGS. 3A, 3C, and 3D, the annular spacer portion 204 includes a peripheral wall 300 defining an end face 210. As illustrated, the peripheral wall 300 is generally cylindrical. It is conceivable that a peripheral wall could be provided in other shapes in alternative embodiments. The peripheral wall 300 defines a first internal surface 302 defining a first internal bore 304, and defines a first external surface 306. As explained in more detail below, the first internal bore 304 is configured to receive a portion of an extended length axle shaft of an extended truck axle therethrough. Further, the first internal bore 304 may be configured to receive a portion of the pre-existing spindle 110, as also explained in more detail below. The peripheral wall 300 is generally sized and configured to be the same, similar, and/or complementary to the size of the axle flange 106.

Referring to FIG. 3B, the peripheral wall 300 further includes a plurality of circumferentially spaced apertures 308. Each circumferentially spaced aperture 308 has an axis parallel with the central axis B-B of the axle extension member 200′. Each circumferentially spaced aperture 308 extends through a thickness of the annular spacer portion 204. The plurality of circumferentially spaced apertures 308 is configured to receive fasteners (e.g., bolts) therethrough to attach the annular spacer portion 204 of the axle extension member 200′ to the axle flange 106 of the truck axle housing 100. The peripheral wall 300 further defines a plurality of radially extending holes 310. The radially extending holes 310 extend from the first external surface 306 to the first internal surface 302 in a direction perpendicular to the central axis B-B. The plurality of radially extending holes 310 is configured to receive fasteners (e.g., screws) therethrough to promote positioning and/or attachment between the annular spacer portion 204 and a retained spindle portion (described in more detail below).

Referring to FIGS. 3A, 3C, and 3D, the spindle portion 206 includes a peripheral wall 312 defining an end face 314. The peripheral wall 312 is generally cylindrical, but could be of any other shape. The peripheral wall 312 defines a second internal surface 316 (shown in FIG. 3D) defining a second internal bore 318, and defines a second external surface 320. The second internal bore 318 is configured to receive therethrough a portion of an extended length axle shaft, which is also received by the first internal bore 304 that is aligned with the second internal bore 318 along the central axis B-B. The second external surface 320 includes wheel bearing support surfaces 214 configured to contact and support inner and outer wheel bearings 120A, 120B (not shown). In certain embodiments, the wheel bearing support surfaces 214 are configured to receive rotational surfaces of the inner and outer wheel bearings of a hub. When rotational surfaces of the inner and outer wheel bearings are received on the wheel bearing support surfaces 214, a vertical load center applied on the single hub piloted wheel is substantially centered between the inner and outer wheel bearings. As shown in FIGS. 3A and 3C, the second external surface 320 further includes a threaded surface 324 positioned proximate to the end face 314 to secure the hub to the spindle portion 206.

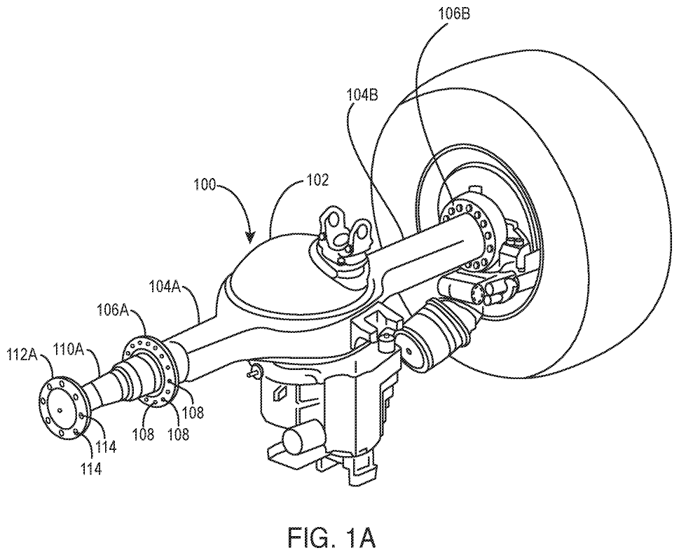

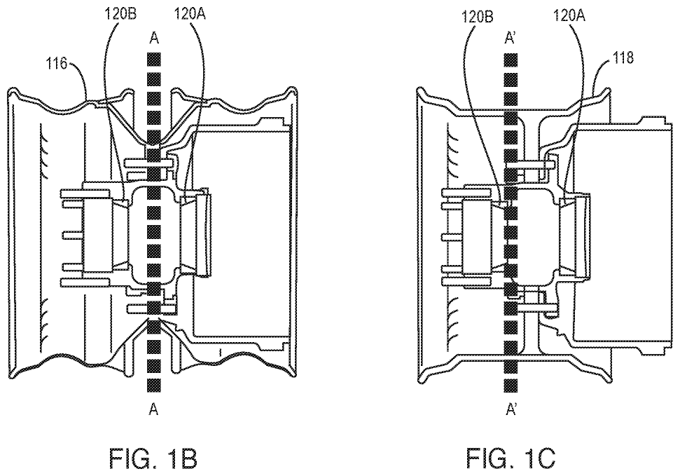

In certain embodiments, the spindle portion 206 is sized, shaped, and otherwise configured to be the same or at least similar to the pre-existing spindle 110 (shown in FIG. 1A). As may be seen, a length of the spindle portion 206 is greater than a length of the annular spacer portion 204, and the spindle portion 206 generally has a smaller diameter than the annular spacer portion 204. Further, referring to FIG. 3D, the second internal bore 318 may include an inboard segment 319A and an outboard segment 319B, where a diameter of the inboard segment 319A is larger than a diameter of the outboard segment 319B. In particular, the inboard segment 319A may be sized and configured to receive a portion of the pre-existing spindle 110. The inboard and outboard segments 319A, 319B may be sized and configured to receive an extended axle shaft therethrough.

The axle extension member 200′ may be made of various materials. For example, the axle extension member 200′ (e.g., annular spacer portion 204 and/or spindle portion 206) may be fabricated of forged steel.

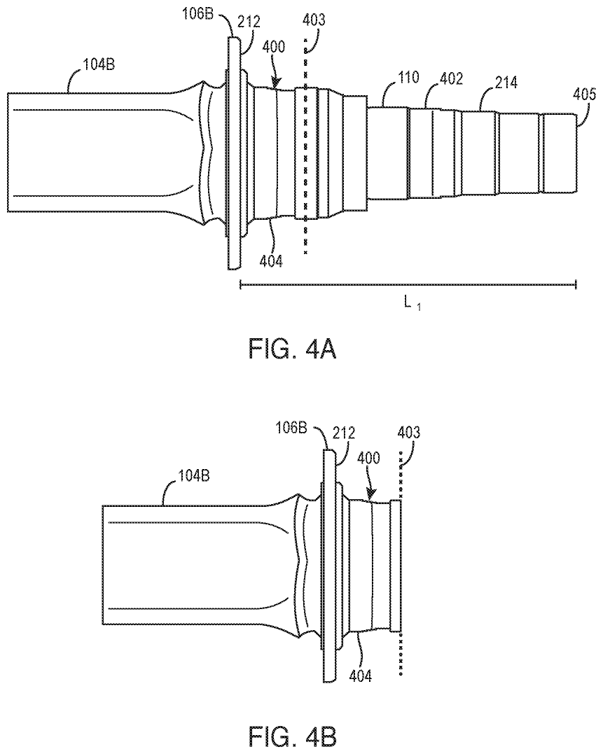

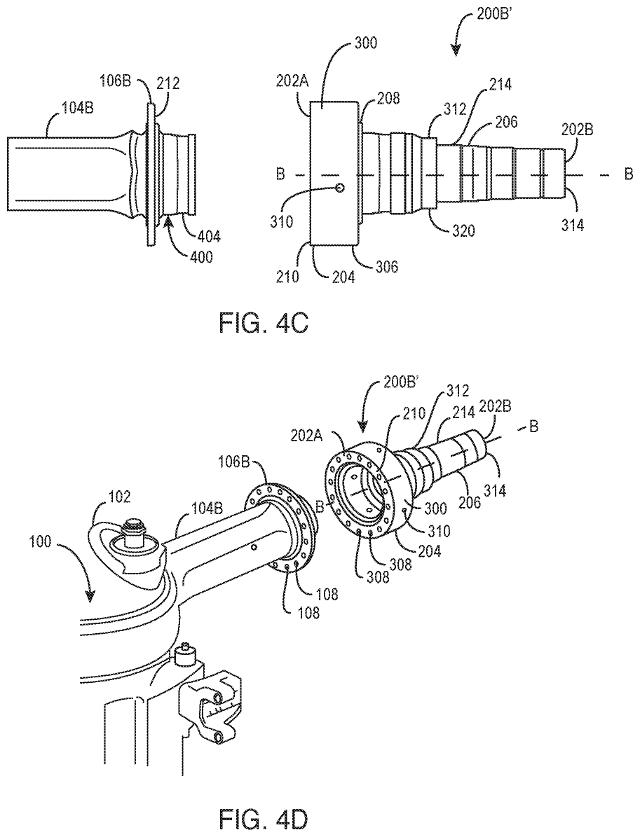

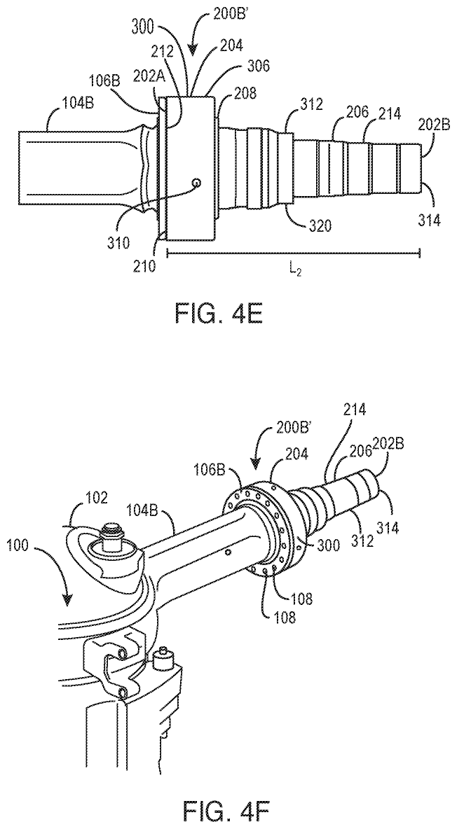

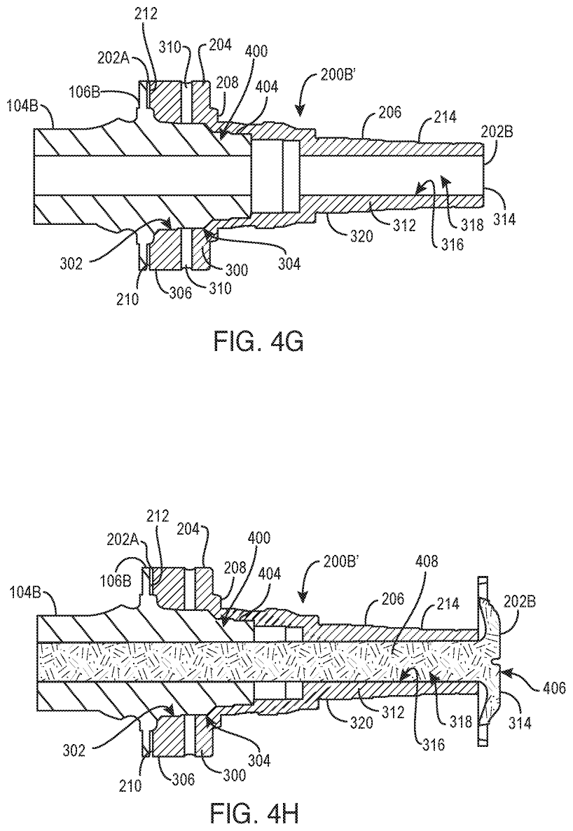

Steps of a method for adjusting a track width of a truck axle may be understood with reference to FIGS. 4A-4H. As a preliminary matter, such a method may include removing wheels, hubs, and brakes, and removing a pre-existing axle shaft (not shown) from at least a portion of the pre-existing spindle 110. Elements not described in conjunction with FIGS. 4A-4H are described hereinabove in conjunction with FIGS. 1A-3D.

FIG. 4A is a side elevation view showing a portion of the housing arm 104B with a pre-existing spindle 110 prior to cutting off at least a portion of the pre-existing spindle 110 along a cut line 403 to divide the pre-existing spindle 110 into a retained spindle segment 400 and a discarded spindle segment 402. As illustrated, the method includes cutting off at least a portion of the pre-existing spindle 110 associated with the truck axle housing 100 (shown in FIG. 1A) along a cut line located at a point between a (right) inboard axle flange 106B and an outboard end 405 of the pre-existing spindle 110. Cutting the pre-existing spindle 110 defines a retained spindle segment 400 (having an outer wall 404) extending from the housing arm and a discarded spindle segment 402 which is subsequently removed from the retained spindle segment 400. It is noted that prior to cutting of the pre-existing spindle 110, the outboard end 405 of the pre-existing spindle 110 had a first length Li from the inboard axle flange 106B. One benefit of retaining a portion of the pre-existing spindle 110 as the retained spindle segment 400 is that the portion provides a mating surface against which an inner surface of an axle extension member may be engaged, thereby promoting secure attachment (e.g., in combination with a bolted or welded connection between an axle extension member and the axle flange 106B). In certain embodiments, however, the entire pre-existing spindle 110 may be removed.

FIG. 4B is a side elevation view of a portion of the housing arm 104B with the retained spindle segment 400 following cutting of the pre-existing spindle 110 along the cut line 403.

Referring to FIGS. 4C and 4D, the method further includes aligning a (right) axle extension member 200B′ with the retained spindle segment 400. As disclosed previously herein with regard to similar axle extension members 200, 200′, the axle extension member 200B′ includes an annular spacer portion 204 (with an end face 210 defining the inboard end 202A), as well as a spindle portion 206 that extends from the annular spacer portion 204. The spindle portion 206 defines an outboard end 202B. The axle extension member 200B′ defines a first internal bore 304 (shown in FIGS. 3D and 4G) in the annular spacer portion 204, and defines a second internal bore 318 (shown in FIGS. 3D and 4G) in the spindle portion 206. The second internal bore 318 is aligned with the first internal bore 304 along the central axis B-B. The plurality of circumferentially spaced apertures 308 of the annular spacer portion 204 is aligned with the plurality of circumferentially spaced apertures 108 of the axle flange 106B to accommodate bolts or other fasteners (not shown).

FIGS. 4E and 4F show the axle extension member 200B′ mounted to the axle flange 106B, the retained spindle segment 400 (shown in FIG. 4C) being disposed in a bore in the axle extension member. In preparation for such attachment, the retained spindle segment 400 is received within the first internal bore 304. In particular, the end face 210 of the annular spacer portion 204 contacts the outboard face 212 of the axle flange 106B, with the first internal bore 304 preferably being sized and shaped to contact the outer wall 404 (shown in FIGS. 4A-4C) of the retained spindle segment 400 received therein. In addition, the holes 108 in the axle flange 106B are aligned with the apertures 308 in the annular spacer portion 204, and the method may include affixing the annular spacer portion 204 to the axle flange 106B. As described above, the peripheral wall 300 of the annular spacer portion 204 defines a plurality of radially extending holes 310. In certain embodiments, the method further includes threading a plurality of set screws (not shown) or other fasteners through the plurality of radially extending holes 310 to press against an outer wall 404 of the retained spindle segment 400. In certain embodiments, the set screws (or other fasteners) may be temporarily or permanently attached. If permanently attached, the set screws (or other fasteners) may provide structural support between the axle extension member 200B′ and the retained spindle segment 400.

In certain embodiments, primary attachment between the annular spacer portion 204 and the axle flange 106B may be made with bolts or other fasteners. For example, an attachment method may include use of a plurality of bolts received by the plurality of circumferentially spaced apertures 308 defined in the annular spacer portion 204 and extending through the end face 210 in a direction substantially parallel to the central axis B-B and the plurality of circumferentially spaced apertures 108 defined in the axle flange 106B. Such a configuration causes the peripheral wall 300 of the annular spacer portion 204 of the axle extension member 200B′ to fit over the retained spindle segment 400. In certain embodiments, the size and configuration of the first internal surface 302 (shown in FIGS. 4G and 4H) is about the same size and shape as the outer wall 404 of the retained spindle segment 400. In this way, the retained spindle segment 400 helps supports the axle extension member 200B′. In certain embodiments, as discussed above, the retained spindle segment 400 may be omitted, and the axle extension member 200B′ may be supported only by fasteners attaching the axle extension member 200B′ to the inboard axle flange 106B.

In certain embodiments, the first internal surface 302 of the annular spacer portion 204 may be threaded and configured to threadably engage the retained spindle segment 400, or may be configured to frictionally engage the retained spindle segment 400 (e.g., via an interference fit that may be accomplished by thermal expansion of the annular spacer portion 204 before fitting around the retained spindle segment 400). When non-permanent attachment is made between the annular spacer portion 204 and the retained spindle segment 400, the truck could easily be reconfigured for a standard axle width by removing the axle extension member 200B′ and replacing it with a standard track width axle housing member. Alternatively, or additionally, the method may include welding at least a portion of the annular spacer portion 204 to the axle flange 106B.

Referring to FIG. 4E, by affixing the annular spacer portion 204 to the axle flange 106B, the outboard end 202B of the axle extension member 200B′ is a second length L2 from the axle flange 106B, and the second length L2 is greater than the first length Li shown in FIG. 4A. In various embodiments, the annular spacer portion 204 may provide for an extension of any desired length, such as between 1 and 12 inches (e.g., 1 inch, 2 inches, 3 inches, 4 inches, 5 inches, etc.) or between 25.4 mm and 304.8 mm (e.g., 25.4 mm, 50.8 mm, 76.2 mm, 101.6 mm, 127 mm, etc.).

FIG. 4G is a cross-sectional view of the attached axle extension member 200B′ and the retained spindle segment 400 of FIG. 4E. As shown in FIG. 4G and FIG. 4H, the retained spindle segment 400 defines an internal bore 124 to accommodate passage of an axle (as shown in FIG. 4H).

Referring to FIG. 4H, the method further includes inserting an extended length axle shaft 408 of an extended length truck axle 406 (e.g., medium or wide axle) through the first internal bore 304 and the second internal bore 318 of the axle extension member 200B′. It is noted that the retained spindle segment 400 is also received by the first internal bore 304, such that a portion of the extended length axle shaft 408 further extends through the internal bore 124 defined by the retained spindle segment 400. Accordingly, in this way, the entire truck axle housing 100 (shown in FIGS. 1A, 2A, 4D, and 4F) does not need to be replaced. The brakes and bearings can be reinstalled as well.

Axle extension members disclosed herein beneficially reduce the time, cost, and complexity of adjusting (e.g., increasing) the axle track width to enable trucks already equipped with standard track rear axles and dual tire wheels to be equipped with super single wheels and tires.

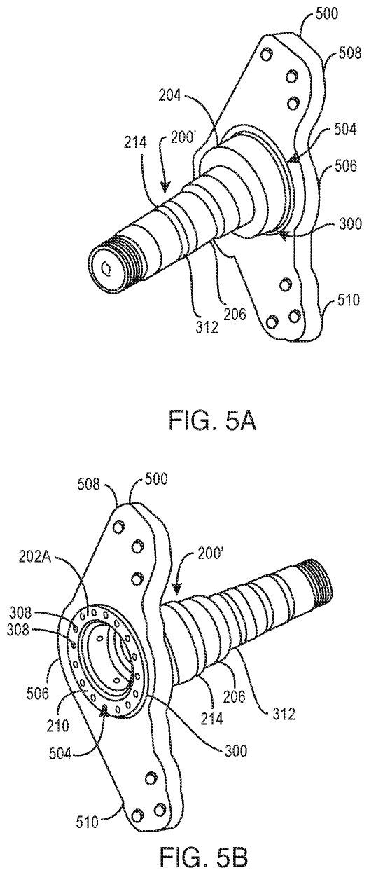

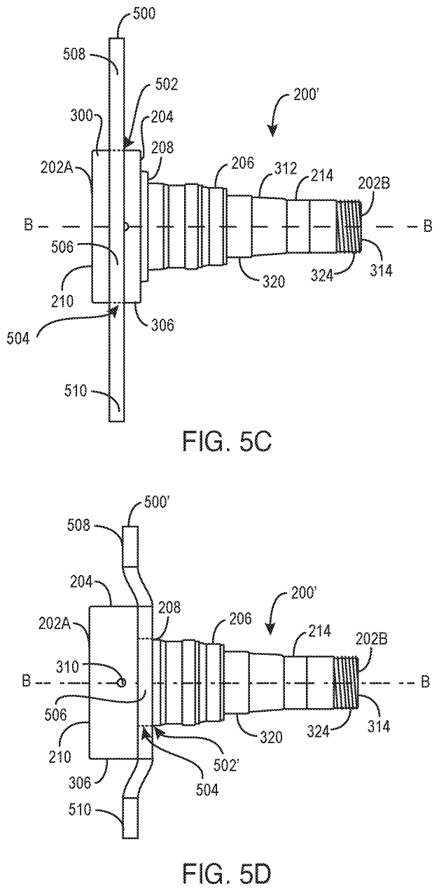

FIGS. 5A-5C illustrate axle extension members 200′ with associated brake mounts 500, 500′. It is noted that when converting from dual tires to super single tires as described herein, truck operators may also desire to convert from drum brakes to air disc brakes. Utilization of a brake mount integrated or otherwise coupled with an axle extension member 200′ may provide a mechanism for mounting the air disc brakes to the axle extension member 200′. Elements not described with regard to FIGS. 5A-5C are described hereinabove with regard to FIGS. 1A-4H.

Referring to FIGS. 5A and 5B, a brake mount 500 includes a center hole 504 defined by a central body portion 506. A top portion 508 of the brake mount 500 extends upward from the central body portion 506, and a bottom portion 510 of the brake mount 500 extends downward from the central body portion 506 in a direction opposing the top portion 508. In certain embodiments, the annular spacer portion 204 of the axle extension member 200′ is inserted into the center hole 504 of the brake mount 500. In this way, the first external surface 306 of the peripheral wall 300 of the annular spacer portion 204 includes a brake mounting region 502 (shown in FIG. 5C). In certain embodiments, the brake mounting region 502 may be attached to an outer perimeter of the annular spacer portion 204 by welding; alternatively, the brake mount 500 may be integrally formed with the annular spacer portion 204. Further, an outboard axle flange 112 is attached to the spindle portion 206 of the axle extension member 200′, as described above.

FIG. 5C is a side elevation view of the axle extension member 200′ and brake mount 500 of FIGS. 5A and 5B, without the wheel flange 112.

Referring to FIG. 5D, in another embodiment, a brake mount 500′ may be attached at a brake mounting region 502′ along a face of the annular spacer portion 204 of an axle extension member 200′. In particular, at least a portion of the spindle portion 206 is received in a center hole 504 of the brake mount 500′ proximate to a mating interface 208 between the annular spacer portion 204 and the spindle portion 206. Accordingly, attachment of the brake mount 500′ to the axle extension member 200′ is positioned outboard relative to the attachment shown in FIG. 5C. As a result, the brake mount 500′ may include top and bottom portions 508, 510 that are offset in an inboard direction relative to a central body portion 506 of the brake mount 500′. In this manner, when the brake mount 500′ is attached to the axle extension member 200′, the top portion 508 and bottom portion 510 may extend inboard relative to the central body portion 506. In certain embodiments, the brake mount 500′ may receive portions of the same fasteners used to couple the annular spacer portion 204 to an inboard wheel flange.

While the invention has been described herein in reference to specific aspects, features, and illustrative embodiments, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Various combinations and sub-combinations of the structures described herein are contemplated and will be apparent to a skilled person having knowledge of this disclosure. Any of the various features and elements as disclosed herein may be combined with one or more other disclosed features and elements unless indicated to the contrary herein. Correspondingly, the invention as hereinafter claimed is intended to be broadly construed and interpreted, as including all such variations, modifications and alternative embodiments, within its scope and including equivalents of the claims.

What is claimed is:

1. An axle extension member configured for attachment to an axle flange of a truck to modify the axle from a standard track configuration to a wider track configuration, the axle extension member comprising:
an annular spacer portion comprising an end face defining an inboard end of the axle extension member, wherein the end face is configured to abut an outboard face of the axle flange; and
a spindle portion extending from the annular spacer portion and defining an outboard end of the axle extension member opposite the annular spacer portion, wherein the spindle portion comprises wheel bearing support surfaces configured to receive wheel bearings of a hub;
wherein the annular spacer portion defines a first internal bore, the spindle portion defines a second internal bore aligned with the first internal bore along a central axis, and the first and second internal bores are configured to receive an extended length axle shaft.

2. The axle extension member of claim 1, wherein the annular spacer portion and the spindle portion are embodied in a unitary member.

3. The axle extension member of claim 2, further comprising a welded interface between the annular spacer portion and the spindle portion.

4. The axle extension member of claim 1, wherein the annular spacer portion defines a plurality of circumferentially spaced apertures extending through the end face in a direction substantially parallel to the central axis, wherein the plurality of circumferentially spaced apertures is aligned with a plurality of circumferentially spaced holes defined in the axle flange, and wherein the plurality of circumferentially spaced apertures is configured to receive a plurality of bolts to permit the axle extension member to be attached to the axle flange.

5. The axle extension member of claim 4, wherein each aperture of the plurality of circumferentially spaced apertures extends through an entire thickness of the annular spacer portion.

6. The axle extension member of claim 1, wherein the first internal bore is sized and shaped to receive therein a retained spindle segment extending in an outboard direction from the axle flange.

7. The axle extension member of claim 6, wherein the first internal bore is sized and shaped to contact at least a portion of an outer wall of the retained spindle segment when the retained spindle segment is received within the first internal bore.

8. The axle extension member of claim 6, wherein a wall of the annular spacer portion defines a plurality of radially extending holes configured to receive a plurality of set screws configured to press against an outer surface of the retained spindle segment.

9. The axle extension member of claim 1, wherein an outboard segment of the second internal bore comprises a first diameter, and an inboard segment of the second internal bore comprises a second diameter that is greater than the first diameter.

10. The axle extension member of claim 1, wherein at least one of the annular spacer portion or the spindle portion comprises forged steel.

11. The axle extension member of claim 1, further comprising a brake mounting region defining at least one attachment feature configured for attachment of a disc brake assembly to the axle extension member.

12. A truck comprising at least one axle extension member, the at least one axle extension member comprising the axle extension member according to claim 1.

13. A method for adjusting track width of a truck axle, the method comprising:
cutting off at least a portion of a pre-existing spindle associated with a truck axle housing at a point between an axle flange and an outboard end of the pre-existing spindle to define a retained spindle segment;
aligning an axle extension member with the retained spindle segment, wherein the axle extension member comprises an annular spacer portion comprising an end face defining an inboard end of the axle extension member, a spindle portion extending from the annular spacer portion and defining an outboard end of the axle extension member, a first internal bore defined in the annular spacer portion, and a second internal bore defined in the spindle portion and being aligned with the first internal bore along a central axis;
receiving the retained spindle segment within the first internal bore; and
affixing the annular spacer portion to the axle flange.

14. The method of claim 13, further comprising removing a pre-existing axle shaft from at least a portion of the pre-existing spindle, and inserting an extended length axle shaft through the first internal bore and the second internal bore.

15. The method of claim 13, wherein said affixing of the annular spacer portion to the axle flange comprises use of a plurality of bolts received by (i) a plurality of circumferentially spaced apertures defined in the annular spacer portion and extending through the end face in a direction substantially parallel to the central axis, and (ii) a plurality of circumferentially spaced holes defined in the axle flange.

16. The method of claim 13, wherein said affixing of the annular spacer portion to the axle flange comprises welding at least a portion of the annular spacer portion to the axle flange.

17. The method of claim 13, wherein a wall of the annular spacer portion defines a plurality of radially extending holes, and the method further comprises threading a plurality of set screws through the plurality of radially extending holes to press against an outer surface of the retained spindle segment.

18. The method of claim 13, wherein:
prior to said cutting off of the at least a portion of the pre-existing spindle, the outboard end of the pre-existing spindle comprises a first distance from the axle flange; and
by affixing the annular spacer portion to the axle flange, the outboard end of the axle extension member comprises a second distance from the axle flange, wherein the second distance is greater than the first distance.
